(19) United States
(12) Patent Application Publication
(10) Pub. No.: US 2026/0105386 A1
(43) Pub. Date: Apr. 16, 2026

(54) SYSTEM FOR TICKETING BASED ON DECENTRALIZED IDENTIFICATION (DID) AND METHOD THEREFOR

(71) Applicant: Myongji University Industry and Academia Cooperation Foundation, Yongin-si (KR)

(72) Inventor: Sang Kyun KIM, Seongnam-si (KR)

(21) Appl. No.: 18/981,166

(22) Filed: Dec. 13, 2024

(30) Foreign Application Priority Data
Oct. 14, 2024 (KR) 10-2024-0139148
Oct. 31, 2024 (KR) 10-2024-0152871

(51) Int. Cl. G06Q 10/02; G06F 21/45; G06F 21/60

(52) U.S. Cl. CPC G06Q 10/02; G06F 21/45; G06F 21/602; G06Q 2220/165

(57) ABSTRACT

Proposed is a method for ticketing based on decentralized identifiers. The method may include uploading a decentralized identification (DID) and a DID document to a verifiable data registry) to register a DID by a user device. The method may also include requesting issuance of a verifiable credential (VC) for a purchased ticket by transmitting the DID by the user device, obtaining a DID document from the VDR through the DID by an issuer device. The method may further include authenticating the ownership of the DID according to an authentication method included in the DID document through interaction with the user device by the issuer device. The method may further include issuing a verifiable credential corresponding to the DID to the user device in response to the ownership of the DID being successfully authenticated by the issuer device.

### STATEMENT REGARDING GOVERNMENT SPONSORED RESEARCH OR DEVELOPMENT

This research was supported by “Support for Activation of Industry-Academia-Research Cooperation (R&D)/IP Advancement and Commercialization for Commercialization of Metaverse International Standard Technology” through the Science and Technology Commercialization Promotion Agency funded by the Ministry of Science and ICT (Project Number: 2710006511).

### CROSS REFERENCE TO RELATED APPLICATION

The present application claims priority to Korean Patent Application No. KR 10-2024-0139148 filed on Oct. 14, 2024, and KR 10-2024-0152871 filed on Oct. 31, 2024, the entire contents of each of which are incorporated herein for all purposes by this reference.

### BACKGROUND

### Technical Field

The present disclosure relates to ticketing technology, and more particularly, to a system for ticketing based on a distributed identifier and a method therefor.

### Description of Related Technology

Traditional media content such as plays, operas, concerts, and sports are constantly receiving attention from many people.

### SUMMARY

One aspect is a system for ticketing based on a distributed identifier and a method therefor.

Another aspect is a method for ticketing based on decentralized identifiers that includes: uploading, by a user device, a DID (decentralized identification) and a DID document to a VDR (Verifiable Data Registry) to register a DID; requesting, by the user device, issuance of a verifiable credential (VC) for a purchased ticket by transmitting the DID; obtaining, by an issuer device, a DID document from the VDR through the DID; authenticating, by the issuer device, ownership of the DID according to an authentication method included in the DID document through interaction with the user device; and issuing, by the issuer device, a verifiable credential corresponding to the DID to the user device if the ownership of the DID is successfully authenticated.

The DID document may include an authentication means and one or more authentication methods for proving ownership of the DID corresponding to the DID.

The authenticating ownership of the DID may include transmitting, by the issuer device, encrypted data so that the issuer device authenticates the ownership of the DID according to an authentication method included in the DID document; decrypting, by the user device, the encrypted data according to the authentication method and returning encrypted data; and authenticating, by the issuer device, the ownership of the DID receiving the decrypted data.

The verifiable credential (VC) may include credential metadata comprising the issuer of the verifiable credential, expiration period, and disposal method, a claim comprising the subject of the credential, and a proof item comprising a value for authenticating the verifiable credential.

The method may include generating, by the user device, a verifiable presentation (VP) including the verifiable credential (VC); providing, by the user device, the verifiable presentation to the verifier device; obtaining, by the verifier device, a DID document through the DID of the verifiable credential included in the verifiable presentation from the VDR; authenticating, by the verifier device, the verifiable presentation; authenticating, by the verifier device, the ownership of the DID according to an authentication method included in the DID document through interaction with the user device if the authentication of the verifiable presentation is successful; and authenticating as a legitimate purchaser of the ticket if the authentication of the ownership of the DID is successful.

The authenticating the verifiable presentation may include authenticating, by the verifier device, the verifiable credential included in the verifiable presentation using the public key of the issuer of the verifiable presentation; and authenticating, by the verifier device, the verifiable presentation using the public key of the holder of the verifiable presentation if the verifier device succeeds in authenticating the verifiable credential.

The authenticating the ownership of the DID may include transmitting encrypted data to authenticate the ownership of the DID according to the authentication method included in the DID document; decrypting, by the user device, the encrypted data according to the authentication method and returning the decrypted data; and receiving, by the verifier device, the decrypted data and completing the authentication.

The verifiable presentation (VP) may include presentation metadata comprising data for reference to verify the verifiable presentation; one or more verifiable credentials (VC); and a proof item comprising a user's signature.

Another aspect is a system for ticketing based on decentralized identifiers that includes: a user device that registers a DID (decentralized identification) and a DID document by uploading the DID document to a VDR (Verifiable Data Registry), and requests the issuance of a verifiable credential (VC) for a purchased ticket by transmitting the DID; and an issuer device that obtains a DID document through the DID from the VDR, and authenticates the ownership of the DID according to an authentication method included in the DID document through interaction with the user device, and issues a verifiable credential corresponding to the DID to the user device if the authentication of the ownership of the DID is successful.

The DID document may include an authentication means and one or more authentication methods for proving ownership of the DID corresponding to the DID.

The issuer device may transmit encrypted data to authenticate the ownership of the DID according to the authentication method included in the DID document, and receive data from the user device in which the encrypted data is decrypted according to the authentication method, thereby authenticating the ownership of the DID.

The verifiable credential (VC) may include credential metadata comprising the issuer of the verifiable credential, expiration period, and disposal method, a claim comprising the subject of the credential, and a proof comprising a value for authenticating the verifiable credential.

The user device may generate a verifiable presentation (VP) including the verifiable credential (VC), provide the verifiable presentation to the verifier device, and the verifier device may obtain a DID document through the DID of the verifiable credential included in the verifiable presentation from the VDR, and authenticate the ownership of the DID according to the authentication method included in the DID document through interaction with the user device if the authentication of the verifiable presentation is successful, and authenticate the user as a legitimate purchaser of the ticket if the authentication of the ownership of the DID is successful.

The verifier device may authenticate the verifiable credential included in the verifiable presentation using the public key of the issuer of the verifiable presentation, and authenticate the verifiable presentation using the public key of the holder of the verifiable presentation if the authentication of the verifiable credential is successful.

To authenticate the ownership of the DID is characterize in that the verifier device may transmit encrypted data to authenticate the ownership of the DID according to the authentication method included in the DID document, and complete the authentication by receiving decrypted data in which the encrypted data is decrypted from the user device.

The verifiable presentation (VP) may include presentation metadata comprising data for reference to verify the verifiable presentation; one or more verifiable credentials (VCs); and a proof item comprising a user's signature.

According to the exemplary embodiment of the present disclosure, it is possible to issue and verify a ticket through a distributed identifier (DID), a verifiable credential (VC), and a verifiable presentation (VP), only the purchaser who first purchased the ticket may become the rightful holder, thereby preventing adverse effects such as ticket blackmail in advance.

### BRIEF DESCRIPTION OF THE DRAWINGS

FIG. 1 is a drawing for explaining the configuration of a system for ticketing based on a distributed identifier according to an exemplary embodiment of the present disclosure.

FIG. 2 is a drawing for explaining a method for registering a decentralized identifier (DID) according to an exemplary embodiment of the present disclosure.

FIG. 3 is a drawing for explaining the configuration of a distributed identifier (DID) according to an exemplary embodiment of the present disclosure.

FIG. 4 is a drawing for explaining the configuration of a distributed identifier (DID) document according to an exemplary embodiment of the present disclosure.

FIG. 5 is a flowchart illustrating a method for authenticating ownership of a DID according to one exemplary embodiment of the present disclosure.

FIG. 6 is a flowchart illustrating a method for authenticating ownership of a DID according to another exemplary embodiment of the present disclosure.

FIG. 7 is a drawing for explaining the structure of a verifiable credential (VC) and a verifiable presentation (VP) according to an exemplary embodiment of the present disclosure.

FIG. 8 is a drawing for explaining a verifiable credential (VC) according to an exemplary embodiment of the present disclosure.

FIGS. 9 and 10 are flowcharts for explaining a method for ticketing based on a distributed identifier according to an exemplary embodiment of the present disclosure.

FIG. 11 is a drawing illustrating a method for generating a verifiable presentation (VP) from a verifiable credential (VC) according to an exemplary embodiment of the present disclosure.

FIG. 12 is a drawing showing a computing device according to an exemplary embodiment of the present disclosure.

### DETAILED DESCRIPTION

There is fierce competition to obtain tickets for performances by singers or bands with large fandoms such as K-POP, or for games by sports stars or teams. As a result, adverse effects such as ticket black market are increasing, which is becoming a factor that hinders healthy cultural and sports viewing. Therefore, means to prevent these adverse effects are required.

The present disclosure can be modified in various ways and has various embodiments, and specific embodiments are exemplified and described in detail in the detailed description. However, this is not intended to limit the present disclosure to specific embodiments, but should be understood to include all modifications, equivalents, or substitutes included in the spirit and technical scope of the present disclosure.

The terms used in the present disclosure are only used to describe specific embodiments and are not intended to limit the present disclosure. The singular expression includes the plural expression unless the context clearly indicates otherwise. In the present disclosure, it should be understood that the terms “comprise” or “have” and the like are intended to specify the presence of a feature, number, step, operation, component, part or combination thereof described in the specification, but do not exclude in advance the possibility of the presence or addition of one or more other features, numbers, steps, operations, components, parts or combinations thereof.

In particular, the terms or words used in this specification and claims described below should not be interpreted as limited to their usual or dictionary meanings, but should be interpreted as meanings and concepts that conform to the technical idea of the present disclosure based on the principle that the inventor can appropriately define the concept of the term in order to explain his or her own disclosure in the best way.

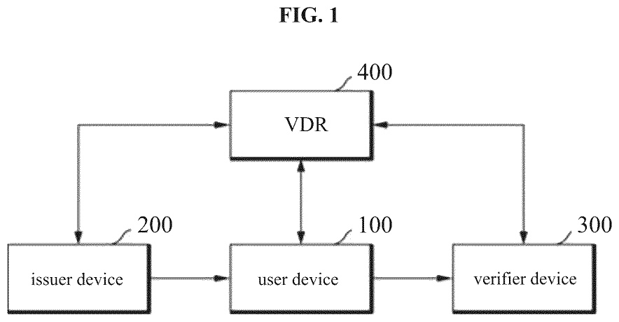

First, the configuration of a system for ticketing based on a distributed identifier according to an embodiment of the present disclosure will be described. FIG. 1 is a drawing for explaining the configuration of a system for ticketing based on a distributed identifier according to an exemplary embodiment of the present disclosure.

Referring to FIG. 1, a ticketing system (10) based on a distributed identifier according to an embodiment of the present disclosure includes a user device (100), an issuer device (200), a verifier device (300), and a VDR (Verifiable Data Registry, 400).

The user device (100) is a device used by a user who purchases a ticket. The user device (100) can perform computing operations and can perform communication through a network or direct connection between devices. As a representative example, the user device (100) can be a smartphone.

The issuer device (200) is a device used by the user of the ticket issuing side, i.e., the issuer. The issuer device (200) can perform computing operations and can perform communication through a network or direct connection between devices. As a representative example, the issuer device (200) can be a workstation-class computing device.

The verifier device (300) is a device used by the user of the ticket verification side, i.e., the verifier. The verifier device (300) can perform computing operations and can perform communication through a network or direct connection between devices. In particular, the verifier device (300) is a device that further includes, for example, a scanner for fingerprint recognition and a camera function for face authentication. Such a verifier device (300) can be exemplified by a smartphone, a kiosk, etc.

VDR (Verifiable Data Registry, 400) is a storage medium existing on a network, and although not shown, is a medium included in one or more computing devices. According to one embodiment, the VDR (400) may be implemented by a plurality of nodes constituting a blockchain network or may be implemented as IPFS (InterPlanetary File System). According to another embodiment, VDR (400) may be implemented through a database server.

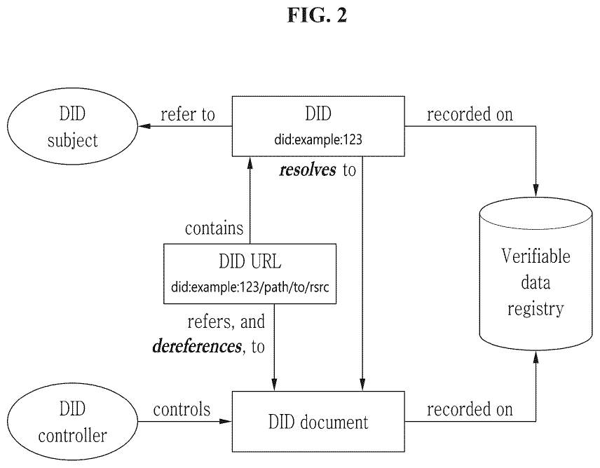

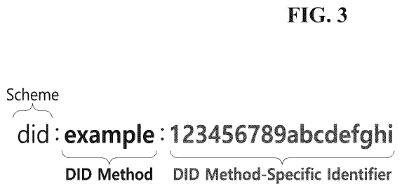

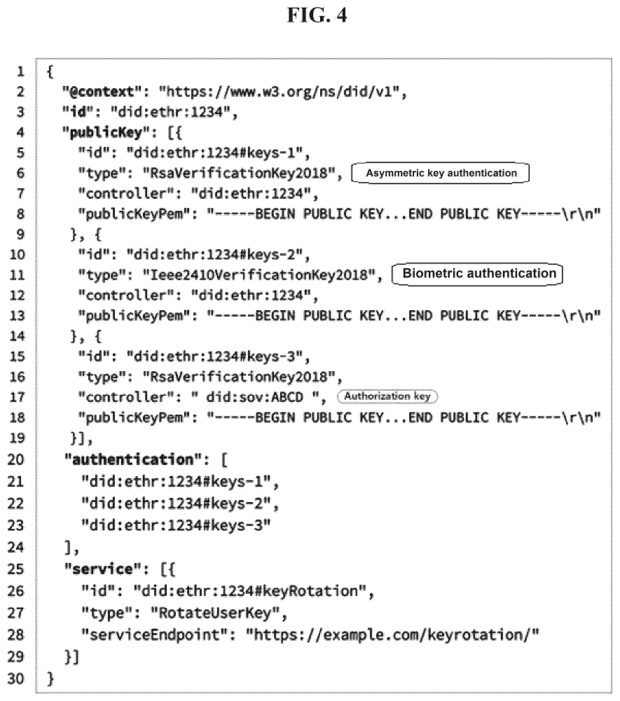

Next, a decentralized identifier (DID) according to an embodiment of the present disclosure will be described. FIG. 2 is a drawing for explaining a method for registering a decentralized identifier (DID) according to an exemplary embodiment of the present disclosure. FIG. 3 is a drawing for explaining the configuration of a distributed identifier (DID) according to an exemplary embodiment of the present disclosure. FIG. 4 is a drawing for explaining the configuration of a distributed identifier (DID) document according to an exemplary embodiment of the present disclosure.

Referring to FIG. 2, the user device (100) registers the DID by generating a DID and a DID document proving it through a DID application (e.g., an app or web application) and storing the generated DID and DID document in the VDR (400). The DID document includes an authentication means (e.g., a public key) and an authentication method for proving ownership of the DID. When proof of ownership of the DID is requested, the DID application can reference the DID document through the location information of the DID document stored in the DID location (e.g., blockchain) in the VDR (400).

Referring to FIG. 3, a DID includes a “did” indicating that it is a DID scheme, a DID method based on a storage location, and a method-specific identifier which is an identifier corresponding to the DID method.

For example, a DID can be generated as “did:btcr:xyv2-xzpq-q9wa-p7t”. According to this, the DID method “btcr” can be used to determine that the DID is generated based on the Bitcoin blockchain. The method-specific identifier “xyv2-xzpq-q9wa-p7t” is generated from a Bitcoin transaction location reference.

As another example, a DID such as “did:sov:mnjkl98uipsndg2hdjdjuf7” can be generated. According to this, the DID method “sov” can be used to determine that the DID is generated based on a dedicated distributed ledger (Sovrin-Hyperledger Indy). The method-specific identifier “mnjkl98uipsndg2hdjdjuf7” can be generated from a UUID (Universally Unique IDentifier) or the user's public key.

Referring to FIG. 4, the DID document includes an authentication means that can prove ownership of the DID. The DID document includes main items such as context, identifier (ID), public key, authentication, and service.

Context (@context) defines the meaning of identifier (id), authentication, and service items in a DID document, as well as the data included. Currently, the context (@context) item is written according to JSON-LD grammar.

The identifier (id) includes the DID of the object identified by the id. The user's DID is included If the purpose is to identify a user, and the object's DID is included if the purpose is to identify an object. For example, the DID of the user who created and registered the DID and DID document is recorded in the identifier (id) field.

The publicKey includes information for authenticating DID ownership. In particular, the public key includes the details of “id”, “type”, “controller”, and “publicKeyPem”.

“id” is used to authenticate ownership of the DID. “type” can include various authentication methods such as asymmetric key authentication (RSA), biometric authentication, elliptic curve asymmetric key authentication, etc. “controller” represents the entity that has authentication authority for “publicKeyPem”. For example, the DID in line 7 represents the DID of a person who has a private key paired with the public key in line 8 in the case of Ethereum-based RSA asymmetric key authentication. “publicKeyPem” represents the data to be used to authenticate ownership of the DID. For example, line 8 represents a public key required for asymmetric authentication.

Authentication includes an ownership authentication method provided in the corresponding DID document. The user device (100) can authenticate DID ownership by selecting one of the three methods of lines 21 to 23.

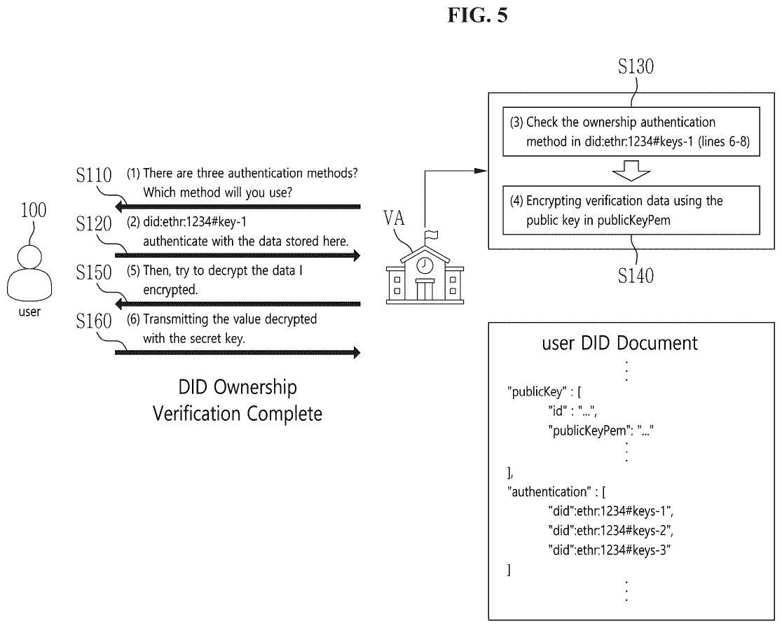

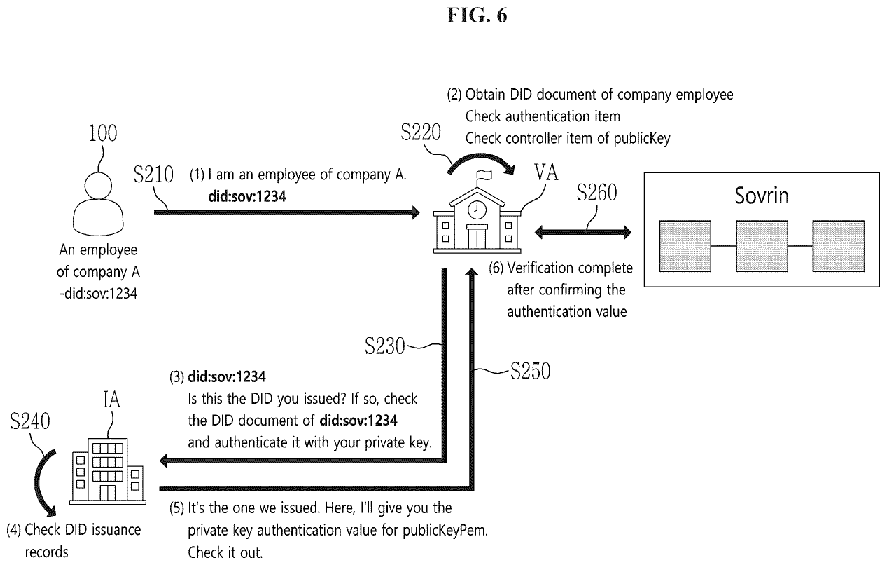

Next, a method for authenticating ownership of a DID according to an embodiment of the present disclosure will be described. FIG. 5 is a flowchart illustrating a method for authenticating ownership of a DID according to one exemplary embodiment of the present disclosure. FIG. 6 is a flowchart illustrating a method for authenticating ownership of a DID according to another exemplary embodiment of the present disclosure. Here, FIG. 5 is an example of DID ownership authentication when a user of a user device (100) has authentication authority for the DID, and FIG. 6 is an example when a DID owner does not have authentication authority for the DID.

In FIG. 5 according to an embodiment, the authentication agency (VA) may be an issuer device (200) or a verifier device (300). Referring to FIG. 5, it is assumed that the user device (100) has registered the DID by uploading the user's DID and DID document to the VDR (400) according to the user's operation.

The authentication agency (VA) that receives the DID from the user device (100) queries the user device (100) to select an authentication method by referring to the authentication field of the DID document at step S110.

Then, the user device (100) selects one of the authentication methods at step S120.

Then, the authentication agency (VA) verifies the authentication method selected by the user device (100) at step S130, and encrypts the verification data using the public key of “publickey pem” according to the authentication method selected by the user device (100) at step S140.

Then, the authentication agency (VA) provides encrypted verification data to the user device (100) at step S150.

Then, the user device (100) decrypts the encrypted verification data using the secret key (private key) at step S160 and provides it to the authentication agency (VA).

Accordingly, the authentication agency (VA) can complete authentication of DID ownership for the user device (100) through the decrypted verification data.

In FIG. 6 according to another embodiment, the issuing agency (IA) may be an issuer device (200), and the authentication agency (VA) may be a verifier device (300). At this time, the issuing agency (IA) assumes that the user device (100) has issued a DID to the user.

The user device (100) can provide the identifier of the issuing agency (IA) and the user's DID to the authentication agency (VA) at step S210.

Then, at step S220, the authentication agency (VA) verifies the authentication field (e.g., line 20 of FIG. 4) of the DID document corresponding to the user's DID “did:sov:1234” and the “controller” field (e.g., line 7 of FIG. 4) of the public key (publickKey).

Accordingly, at step S230, the authentication agency (VA) requests the issuing agency (IA) for a private key, which is an authentication means corresponding to the DID “did:sov:1234”.

Then, the issuing agency (IA) verifies the issuance history at step S240 and provides the private key to the authentication agency (VA) at step S250. Accordingly, the authentication agency (VA) can verify the private key and complete the authentication.

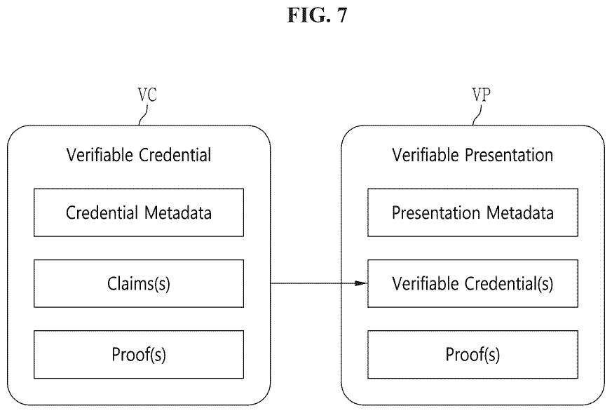

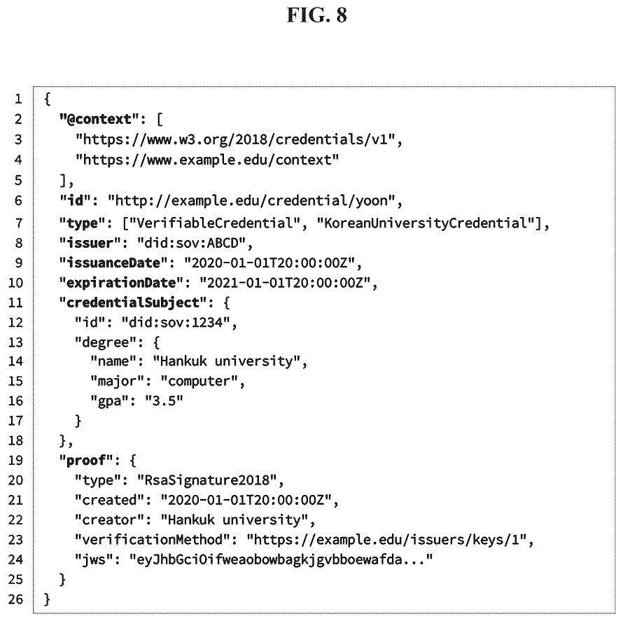

Next, a verifiable credential (VC) and a verifiable presentation (VP) according to an embodiment of the present disclosure will be described. FIG. 7 is a drawing for explaining the structure of a verifiable credential (VC) and a verifiable presentation (VP) according to an exemplary embodiment of the present disclosure. FIG. 8 is a drawing for explaining a verifiable credential (VC) according to an exemplary embodiment of the present disclosure.

Referring to FIG. 7, a verifiable credential (VC) includes credential metadata, claim, and proof items.

Credential metadata includes the issuer, expiration period, and disposal method, etc. of the verifiable credential. A claim is information about the ID attribute of the credential subject and is stored in the format of subject-attribute-value. That is, a claim includes information related to the subject of the credential referenced by the VC. A proof includes a value for authenticating a verifiable credential. For example, various encryption technologies such as RSA, ECDSA, and biometric authentication may be included. In particular, a proof includes a signature of the VC issuer.

More specifically, referring to FIG. 8, a verifiable credential (VC) includes items such as context (@context), identifier (id), type, issuer, issuance date (issuanceDate(validFrom)), expiration date (expireDate(validUntil)), credential subject (credentialSubject), credential scheme (credentialSchema), credential status (credentialStatus), and proof (proof).

Context(@context) is to define the value of data. “https://www.w3.org/2018/credentials/v1” in line 3 must be included as an official VC context. “https://www.example.edu/context” in line 4 is a context that is created and inserted directly when additional context is needed for the service under development.

The Identifier (Id) field contains the identifier of the VC, such as “http://example. edu//credential/yoon ” in line 6. Meanwhile, the DID identifier in line 12 is the identifier of the user (or object) identified by the VC.

In the type, the “VerifiableCredential” type in line 7 means that the VC is created according to the basic VC data structure defined in the VC official context, and “KoreanUniversityCredentia” means that the data required for the graduation certificate is created according to the data structure defined in the self-creation context.

The issuer represents the person or organization that issued the VC. The issuance date (issuanceDate(validFrom)) defines when the VC is valid. The expiration date (expireDate(validUntil)) defines how long the VC is valid. The credentialSubject is an entity that contains claim data. The credentialSchema can define a scheme for specific properties of a claim or VC. This can be used to restrict non-mandatory properties of a VC to required properties.

CredentialStatus is intended to indicate the status of the credential (valid or expired).

The proof includes information for VC authentication. Here, the “type” of line 20 is the type of the proof. “proofPurpose” prevents misuse other than the intended purpose. The “VerificationMethod” of line 23 is the address (url) where the public key is stored. “created” is the time when the proof was created. “Value” includes the value in which the digital signature binary data is encoded.

Referring again to FIG. 7, a verifiable presentation (VP) includes presentation metadata, one or more verifiable credentials (VC), and proof(s) items.

Presentation metadata includes data that can be referenced for VP authentication, such as type, terms of use, and evidence.

Verifiable Credentials (VC) selectively includes a VC with a required ID attributes and a required ID attribute among claims in the VC. Accordingly, this enables privacy protection.

The proof(s) item of VP includes the user's signature. Compared to VC, the proof(s) item of VC includes the issuer's signature. Various encryption technologies can be used through proof(s).

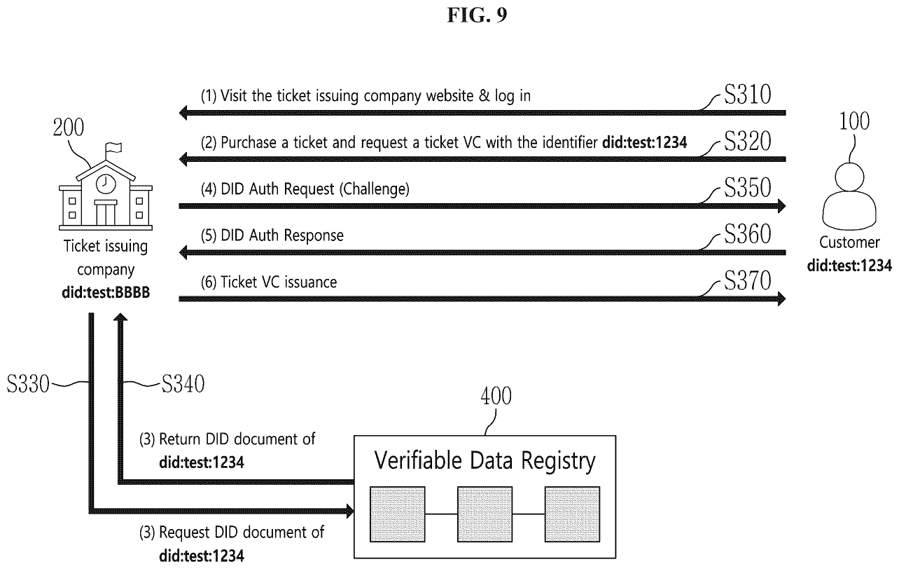

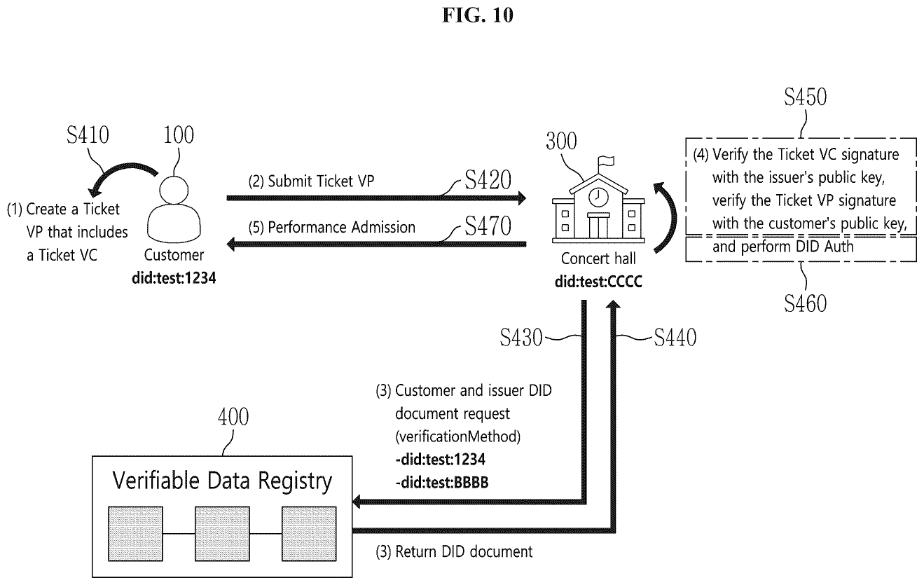

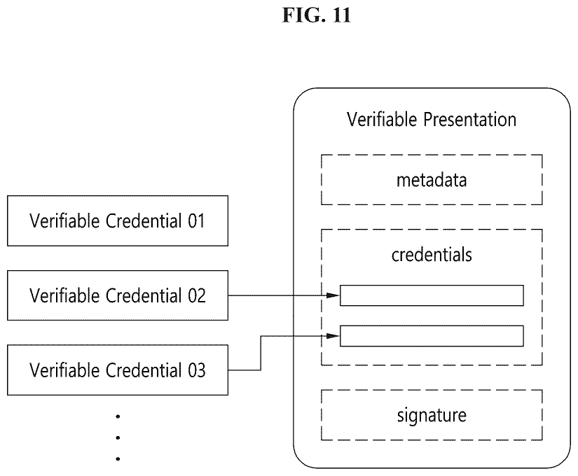

Next, a method for ticketing based on a distributed identifier according to an embodiment of the present disclosure will be described. FIGS. 9 and 10 are flowcharts for explaining a method for ticketing based on a distributed identifier according to an exemplary embodiment of the present disclosure. FIG. 11 is a drawing illustrating a method for generating a verifiable presentation (VP) from a verifiable credential (VC) according to an exemplary embodiment of the present disclosure.

In the embodiments of FIGS. 9 to 11, the user of the user device (100) may be a ticket purchaser, the issuer device (200) may be a device of a ticket sales company, and the verifier device (300) may be a device of a concert hall management company.

First, referring to FIG. 9, it is assumed that the user device (100) has registered a DID (decentralized identification) and a DID document by uploading them to the VDR (400). The DID document includes an authentication means and one or more authentication methods for proving ownership of the DID in response to the DID.

The user device (100) connects to the issuer device (200) at step S310, and then pays the amount for the ticket to the issuer device (200) at step S320, and transmits the DID to request the issuance of a verifiable credential (VC) corresponding to the ticket. According to an additional embodiment, for example, if all three people are going to the concert, the DIDs of all three people can be entered and the amounts for the tickets for all three people can be paid. In this case, the procedure described below can be performed for all three people.

Then, the issuer device (200) requests a DID document by transmitting the DID to the VDR (400) at step S330, and obtains the DID document from the VDR (400) at step S340.

Then, the issuer device (200) performs an authentication procedure for the ownership of the DID according to the authentication method included in the DID document through interaction with the user device (100).

Specifically, the issuer device (200) transmits encrypted data so that the user device (100) can authenticate the DID ownership according to the authentication method included in the DID document at step S350. The data can be encrypted using the public key of “publickey pem”.

Accordingly, the user device (100) decrypts the encrypted data according to the authentication method at step S360 and then returns the decrypted data to the issuer device (200). At this time, for example, data encrypted with a public key can be decrypted using a private key.

The ownership of the DID can be authenticated by the issuer device (200) receiving such decrypted data.

If the authentication of ownership of the DID is successful, the issuer device (200) generates a verifiable credential (VC) corresponding to the DID at step S370 and issues the generated verifiable credential (VC) to the user device (100).

Here, a verifiable credential (VC) includes credential metadata including the issuer, expiration period, and disposal method of the verifiable credential, a claim including the subject of the credential, and a proof item including a value for authenticating the verifiable credential.

Referring to FIG. 10, a user device (100) is issued a verifiable credential (VC) based on a DID according to the method described in FIG. 9. According to one embodiment, the verifiable credential (VC) may be stored in a wallet.

In order to authenticate that the user is a legitimate ticket purchaser and to present the ticket to the concert hall management company, the user device (100) inputs the user's signature at step S410 to generate a verifiable presentation (VP) including a verifiable credential (VC). At this time, according to an additional embodiment, if multiple (e.g., three) verifiable credentials (VCs) are issued, one verifiable presentation (VP) including multiple (e.g., three) verifiable credentials (VCs) can be generated.

A verifiable presentation (VP) includes presentation metadata including data for reference to verify the verifiable presentation, one or more verifiable credentials (VC), and a proof item including a user's signature.

After generating a verifiable presentation (VP), the user device (100) provides the verifiable presentation (VP) corresponding to the ticket to the verifier device (300) at step S420.

Then, the verifier device (300) requests a DID document by transmitting the DID of the verifiable credential (VC) included in the verifiable presentation (VP) to the VDR (400) at step S430, and obtains the DID document from the VDR (400) at step S440.

Then, the verifier device (300) authenticates the verifiable presentation (VP). To this end, the verifier device (300) first authenticates the verifiable presentation (VP) using the public key of the issuer of the verifiable credential (VC) included in the verifiable presentation (VP), i.e., the issuer device (200) at step S450. And then, if the authentication of the verifiable credential (VC) is successful, the verifier device (300) authenticates the signature included in the verifiable presentation (VP) using the public key of the holder of the verifiable presentation (VP), i.e., the user device (100) at step S460.

If the authentication of the verifiable presentation (VP) is successful, the verifier device (300) can authenticate the ownership of the DID according to the authentication method included in the DID document through interaction with the user device (100) at step S470. Specifically, the verifier device (300) can request the user device (100) to authenticate the ownership of the DID according to the authentication method included in the DID document. Accordingly, the user device (100) may authenticate ownership of the DID by returning data for authentication to the issuer device (200) according to the authentication method.

According to an embodiment, if the authentication method included in the DID document is asymmetric key authentication, the verifier device (300) may transmit encrypted data to the user device (100). Accordingly, the user device (100) may decrypt the encrypted data and return the decrypted data to the issuer device (200) to perform authentication. As a specific example of step S470, the ticket inspector may obtain the user's face image, fingerprint information, or user's private key according to the authentication method of the DID registered in the ticket VP by using a mobile phone, i.e., a camera or a fingerprint recognition device of the verifier device (300), and may authenticate the ownership of the DID.

In this way, if the authentication of ownership of the DID is successful, the verifier device (300) can authenticate the user of the user device (100) that presented the verifiable presentation (VP) as the legitimate purchaser of the ticket.

The method for ticketing based on a distributed identifier according to the present disclosure described above allows only the person who entered at the time of purchase (the DID of an acquaintance including the purchaser) to enter the concert hall. In this way, the present disclosure has the effect of fundamentally blocking illegal transfer of tickets because only the DID holder registered in the ticket can enter. And only the DID holder registered in the ticket can be authenticated using a personal key (e.g., fingerprint, face, pupil).

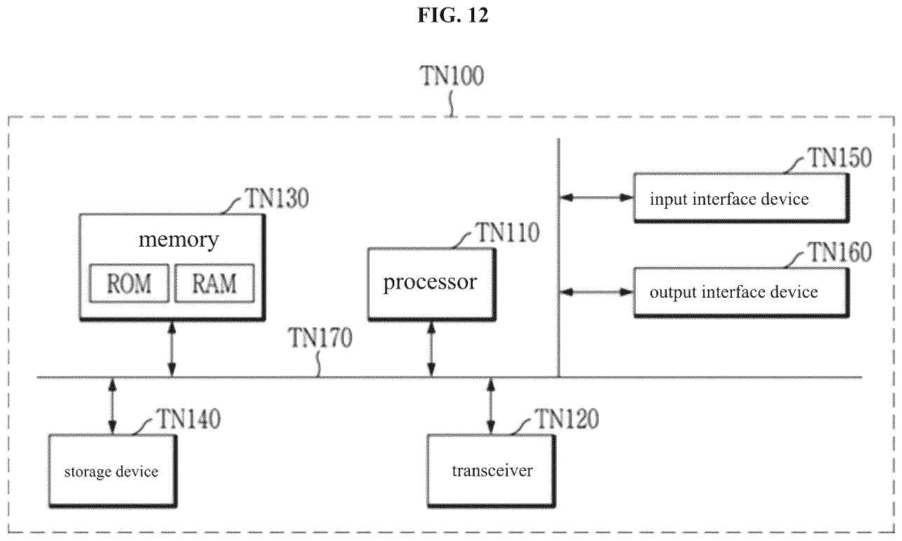

FIG. 12 is a drawing showing a computing device according to an exemplary embodiment of the present disclosure. The computing device (TN100) of FIG. 12 may be a device described in this specification, such as a user device (100), an issuer device (200), a verifier device (300), and a VDR (400).

In the embodiment of FIG. 12, the computing device (TN100) may include at least one processor (TN110), a transceiver (TN120), and a memory (TN130). In addition, the computing device (TN100) may further include a storage device (TN140), an input interface device (TN150), an output interface device (TN160), etc. The components included in the computing device (TN100) may be connected by a bus (TN170) to communicate with each other.

The processor (TN110) can execute a program command stored in at least one of the memory (TN130) and the storage device (TN140). The processor (TN110) may mean a central processing unit (CPU), a graphics processing unit (GPU), or a dedicated processor on which methods according to embodiments of the present disclosure are performed. The processor (TN110) may be configured to implement procedures, functions, methods, etc. described in relation to embodiments of the present disclosure. The processor (TN110) may control each component of the computing device (TN100).

Each of the memory (TN130) and the storage device (TN140) may store various information related to the operation of the processor (TN110). Each of the memory (TN130) and the storage device (TN140) may be configured with at least one of a volatile storage medium and a nonvolatile storage medium. For example, the memory (TN130) can be configured with at least one of a read-only memory (ROM) and a random access memory (RAM).

The transceiver (TN120) can transmit or receive wired or wireless signals. The transceiver (TN120) may be connected to a network and perform communication.

In particular, various functions of, for example, a user device (100), an issuer device (200), a verifier device (300), and a VDR (400) according to an embodiment of the present disclosure may be implemented in the form of a readable program by a computer means and stored in a memory (TN130) and then executed by a processor (TN110). Alternatively, various functions of, for example, a user device (100), an issuer device (200), a verifier device (300), and a VDR (400) may become sub-modules of the processor (TN110).

Meanwhile, various methods according to the embodiments of the present disclosure described above may be implemented in the form of a program readable by various computer means and recorded on a computer-readable recording medium. Here, the recording medium may include program commands, data files, data structures, etc., alone or in combination. The program commands recorded on the recording medium may be those specially designed and configured for the present disclosure or may be those known to and usable by those skilled in the art of computer software. For example, the recording medium includes magnetic media such as hard disks, floppy disks, and magnetic tapes, optical media such as CD-ROMs and DVDs, magneto-optical media such as floptical disks, and hardware devices specially configured to store and execute program commands such as ROMs, RAMs, flash memories, etc. Examples of program commands may include not only machine language generated by a compiler, but also high-level language wires that can be executed by a computer using an interpreter, etc. These hardware devices may be configured to operate as one or more software modules to perform the operations of the present disclosure, and vice versa.

Although one embodiment of the present disclosure has been described above, those skilled in the art will be able to modify and change the present disclosure in various ways by adding, changing, deleting or adding components, etc., within the scope that does not depart from the spirit of the present disclosure described in the claims, and this will also be included within the scope of the rights of the present disclosure.

What is claimed is:

1. A method for ticketing based on decentralized identifiers, comprising:
uploading, by a user device, a decentralized identification (DID) and a DID document to a verifiable data registry (VDR) to register a DID;
requesting, by the user device, issuance of a verifiable credential (VC) for a purchased ticket by transmitting the DID;
obtaining, by an issuer device, a DID document from the VDR through the DID;
authenticating, by the issuer device, the ownership of the DID according to an authentication method included in the DID document through interaction with the user device; and
issuing, by the issuer device, a verifiable credential corresponding to the DID to the user device if the ownership of the DID is successfully authenticated.

2. The method of claim 1, wherein the DID document comprises an authentication means and one or more authentication methods for proving the ownership of the DID corresponding to the DID.

3. The method of claim 1, wherein authenticating the ownership of the DID comprises:
transmitting, by the issuer device, encrypted data so that the issuer device authenticates the ownership of the DID according to an authentication method included in the DID document;
decrypting, by the user device, the encrypted data according to the authentication method and returning encrypted data; and
authenticating, by the issuer device, the ownership of the DID receiving the decrypted data.

4. The method of claim 1, wherein the verifiable credential (VC) comprises
credential metadata comprising the issuer of the verifiable credential, expiration period, and disposal method,
a claim comprising the subject of the credential, and
a proof item comprising a value for authenticating the verifiable credential.

5. The method of claim 1, further comprising:
generating, by the user device, a verifiable presentation (VP) including the verifiable credential (VC);
providing, by the user device, the verifiable presentation to the verifier device;
obtaining, by the verifier device, a DID document through the DID of the verifiable credential included in the verifiable presentation from the VDR;
authenticating, by the verifier device, the verifiable presentation;
authenticating, by the verifier device, the ownership of the DID according to an authentication method included in the DID document through interaction with the user device if the authentication of the verifiable presentation is successful; and
authenticating as a legitimate purchaser of the ticket if the authentication of the ownership of the DID is successful.

6. The method of claim 5, wherein authenticating the verifiable presentation comprises:
authenticating, by the verifier device, the verifiable credential included in the verifiable presentation using the public key of the issuer of the verifiable presentation; and
authenticating, by the verifier device, the verifiable presentation using the public key of the holder of the verifiable presentation in response to the verifier device succeeding in authenticating the verifiable credential.

7. The method of claim 5, wherein authenticating the ownership of the DID comprises:
transmitting encrypted data to authenticate the ownership of the DID according to the authentication method included in the DID document;
decrypting, by the user device, the encrypted data according to the authentication method and returning the decrypted data; and
receiving, by the verifier device, the decrypted data and completing the authentication.

8. The method of claim 5, wherein the verifiable presentation (VP) comprises:
presentation metadata comprising data for reference to verify the verifiable presentation;
one or more verifiable credentials (VC); and
a proof item comprising a user's signature.

9. A system for ticketing based on decentralized identifiers, comprising:
a user device configured to:
register a decentralized identification (DID) and a DID document by uploading the DID document to a verifiable data registry (VDR), and
request the issuance of a verifiable credential (VC) for a purchased ticket by transmitting the DID; and
an issuer device configured to:
obtain a DID document through the DID from the VDR, authenticate the ownership of the DID according to an authentication method included in the DID document through interaction with the user device, and
issue a verifiable credential corresponding to the DID to the user device in response to the authentication of the ownership of the DID being successful.

10. The system of claim 9, wherein the DID document comprises an authentication means and one or more authentication methods for proving the ownership of the DID corresponding to the DID.

11. The system of claim 9, wherein the issuer device is configured to:
transmit encrypted data to authenticate the ownership of the DID according to the authentication method included in the DID document, and
receive data from the user device in which the encrypted data is decrypted according to the authentication method to authenticate the ownership of the DID.

12. The system of claim 9, wherein the verifiable credential (VC) comprises:
credential metadata comprising the issuer of the verifiable credential, expiration period, and disposal method,
a claim comprising the subject of the credential, and
a proof comprising a value for authenticating the verifiable credential.

13. The system of claim 9, wherein the user device is configured to:
generate a verifiable presentation (VP) including the verifiable credential (VC),
provide the verifiable presentation to the verifier device, and
wherein the verifier device is configured to:
obtain a DID document through the DID of the verifiable credential included in the verifiable presentation from the VDR, and
authenticate the ownership of the DID according to the authentication method included in the DID document through interaction with the user device in response to the authentication of the verifiable presentation being successful, and
authenticate the user as a legitimate purchaser of the ticket in response to the authentication of the ownership of the DID being successful.

14. The system of claim 13, wherein the verifier device is configured to:
authenticate the verifiable credential included in the verifiable presentation using the public key of the issuer of the verifiable presentation, and
authenticate the verifiable presentation using the public key of the holder of the verifiable presentation in response to the authentication of the verifiable credential being successful.

15. The system of claim 13, wherein to authenticate the ownership of the DID the verifier device is configured to:
transmit encrypted data to authenticate the ownership of the DID according to the authentication method included in the DID document, and
complete the authentication by receiving decrypted data in which the encrypted data is decrypted from the user device.

16. The system of claim 13, wherein the verifiable presentation (VP) comprises:
presentation metadata comprising data for reference to verify the verifiable presentation;
one or more verifiable credentials (VCs); and
a proof item comprising a user's signature.
